(19) United States
(12) Patent Application Publication
(10) Pub. No.: US 2026/0295788 A1
(43) Pub. Date: Oct. 1, 2026

(54) STRIKER LIFTING MECHANISM OF A POWER TOOL AND A SAFETY FIRING CONTROL METHOD

(71) Applicant: APACH INDUSTRIAL CO., LTD., TAICHUNG CITY (TW)

(72) Inventor: Bo-Fang TSAI, TAICHUNG CITY (TW)

(21) Appl. No.: 19/091,838

(22) Filed: Mar. 27, 2025

(51) Int. Cl. B25C 1/00; B25C 1/04; B25C 1/06

(52) U.S. Cl. CPC B25C 1/008; B25C 1/041; B25C 1/06

(57) ABSTRACT

A striker lifting mechanism for a power tool includes: a striker drive mechanism for moving the striker; the striker includes a climbing tooth and a stop tooth. The stop tooth has an inclined surface and a stop surface; a gear has a driving tooth for lifting the climbing tooth; a gear drive mechanism for rotating the gear; a stop member is assembled on another side of the striker, and the stop member includes a convex portion with a limiting surface abutting against the stop surface and an abutting surface abutting against the inclined surface; a stop-member drive mechanism for driving the stop member to swing to an abutting state or a separated state; a central control unit for controlling the rotation or stopping of the gear drive mechanism, controlling the striker drive mechanism to drive the striker to move and to drive the stop member to swing.

### BACKGROUND

### Field of the Invention

The present invention relates to a nail gun, and more particularly to a striker lifting mechanism of the nail gun and a safety firing control method for the same.

### Description of Related Art

A nail gun is a device used for nailing. It mainly drives a striker to move downward through a cylinder. One side of the striker includes a plurality of teeth, which are engaged with a lifting wheel. When the striker moves to the lower dead center, the lifting wheel drives the striker to move upward, lifting the striker to the top dead center to wait for nailing. Moreover, the conventional nail gun is equipped with a safety device to prevent the nail gun from being fired accidentally.

However, the safety device of the conventional nail gun has problems such as complex structure and relatively serious wear and tear. And the position waiting for nailing is at a high point, which is extremely likely to cause accidental touch or the failure of the safety device, resulting in accidental nailing.

### SUMMARY

The present invention provides a striker lifting mechanism of a power tool, and its main objective is to provide a striker lifting mechanism with a simple structure and good safety.

Additionally, the present invention further provides a control method for the aforesaid striker lifting mechanism of the power tool.

To achieve the aforesaid objective, a striker lifting mechanism of a power tool provided by the present invention comprises:
a striker drive mechanism configured to drive a striker to move;
the striker being power-connected to the striker drive mechanism and including a first side surface and a second side surface opposite to each other, the first side surface including a plurality of climbing teeth, the second side surface including a plurality of stop teeth, wherein each of the stop teeth includes an inclined surface and a stop surface, and the stop surface faces away from the striker drive mechanism;
a gear assembled on one side of the striker and including at least one driving tooth configured to abut against the climbing teeth to lift the climbing teeth;
a gear drive mechanism power-connected to the gear to drive the gear to rotate;
a stop member assembled on another side of the striker and including a convex portion, wherein the convex portion includes a limiting surface and an abutting surface, the limiting surface is configured to abut against the stop surface of the stop teeth, the abutting surface is configured to abut against the inclined surface of the stop teeth, the stop member is capable of being in an abutting state or a separated state, when the stop member is in the abutting state, the convex portion is in contact with the stop teeth, and when the stop member is in the separated state, the convex portion is away from the stop teeth;
a stop-member drive mechanism power-connected to the stop member and configured to drive the stop member to swing to the abutting state or the separated state;
a central control unit control-connected to the gear drive mechanism, the striker drive mechanism, and the stop-member drive mechanism, wherein the central control unit controls the gear drive mechanism to rotate or stop rotating, the central control unit controls the gear drive mechanism drive the striker to move, and the central control unit controls the stop-member drive mechanism to drive the stop member to swing; and
one end of the striker that is not connected to the striker drive mechanism includes a striking section, the striker is further provided with a housing, the housing includes a pointed tip, the striker is capable of moving down to an upper dead center, a lower dead center, and a standby position, when the striker is in the lower dead center, the striking section extends out of the pointed tip of the housing, when the striker is in the standby position, the striking section retracts into the pointed tip of the housing, when the striker is in the standby position, the striking section is close to the pointed tip, and when the striker is in the upper dead center, the striking section is away from the pointed tip.

The present invention further provides a safety firing control method for the striker lifting mechanism of the power tool, comprising:
a lifting step: having a power-transmission state between the gear drive mechanism and the climbing teeth, by the central control unit, driving the gear drive mechanism to rotate, by the driving tooth, lifting the climbing teeth, the striker moving upward from the standby position to the upper dead center, the stop member being in an abutting state, and the convex portion of the stop member contacting the stop teeth;
a firing step: driving the stop member to be in a separated state when the striker moves to the upper dead center, so as to have a power-separation state between the gear drive mechanism and the climbing teeth, and the striker drive mechanism driving the striker to move downward to the lower dead center;
a retracting step: having the power-transmission state between the gear drive mechanism and the climbing teeth when the striker moves to the lower dead center, driving the gear drive mechanism to rotate, the driving tooth lifting the climbing teeth, driving the striker to move upward from the lower dead center to the standby position, driving the stop member to be in an abutting state, and the convex portion of the stop member contacting the stop teeth.

As is evident from the foregoing, once the gear drive mechanism is power-connected to the gear, and a power-transmission state and a power-separation state exist between the gear drive mechanism and the climbing teeth, the driving teeth of the gear are capable of lifting the climbing teeth and driving the striker to move upward. Meanwhile, this setup ensures that no interference or restriction occurs during the downward movement of the striker. In addition, the stop-member drive mechanism drives the stop member to swing to the abutting state or the separated state. The abutting state ensures that the striker will not be interfered with or restricted when moving up, and can prevent the striker from moving down due to accidental touch at the standby position or when moving up. The separated state ensures that the striker can quickly move from the upper dead center P to the lower dead center, providing a striker lifting mechanism and a firing safety device with a simple structure and good safety.

### BRIEF DESCRIPTION OF THE DRAWINGS

FIG. 1 is a perspective view of the striker lifting mechanism of the power tool of the present invention;

FIG. 2 is a perspective view of the striker lifting mechanism of the power tool of the present invention;

FIG. 3 is a schematic diagram of the striker of the present invention moving from the standby position to the upper dead center;

FIG. 4 is a schematic diagram of the striker of the present invention being at the upper dead center;

FIG. 5 is a schematic diagram of the striker of the present invention moving from the upper dead center to the lower dead center;

FIG. 6A is a schematic diagram of the striker of the present invention being at the lower dead center;

FIG. 6B is a magnified view of a part of FIG. 6A;

FIG. 7 is a schematic diagram of the striker of the present invention moving from the lower dead center to the standby position;

FIG. 8A is a schematic diagram of the striker of the present invention being at the standby position;

FIG. 8B is a magnified view of a part of FIG. 8A;

FIG. 9 is a schematic diagram of the striker lifting mechanism of the power tool of the present invention;

FIG. 10 is a schematic diagram of the striker lifting mechanism of the power tool of the present invention;

FIG. 11 is an exploded view of an embodiment of the present invention;

FIG. 12 is an exploded view of another embodiment of the present invention;

FIG. 13 is a perspective view of another embodiment of the present invention;

FIG. 14 is a side view of another embodiment of the present invention;

FIG. 15 is a magnified view of a part of another embodiment of the present invention in a power transmission state;

FIG. 16 is a magnified view of a part of another embodiment of the present invention in a power separation state; and

FIG. 17 is a safety firing control method for the striker lifting mechanism of the power tool of the present invention.

### DETAILED DESCRIPTION

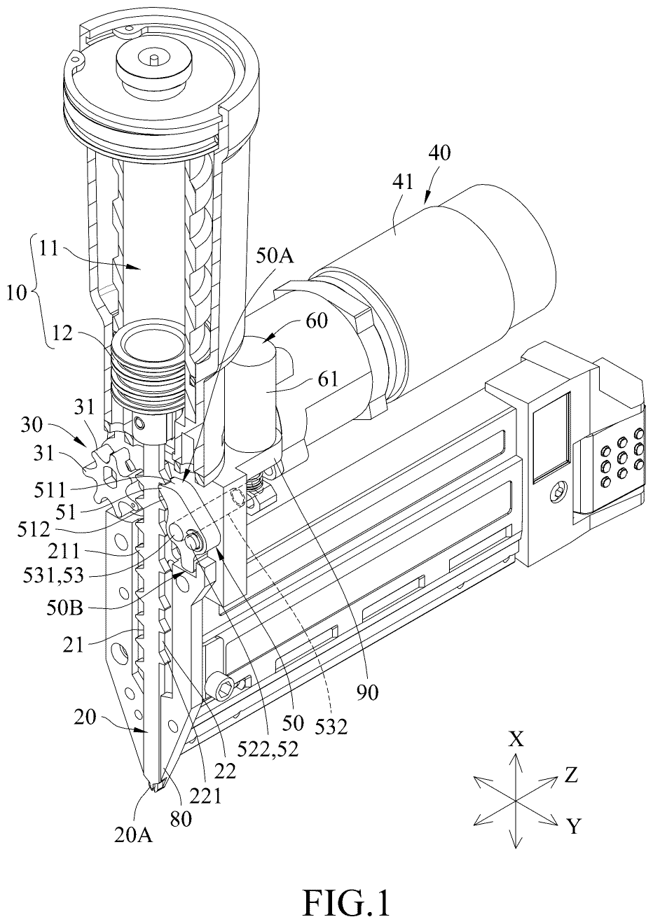

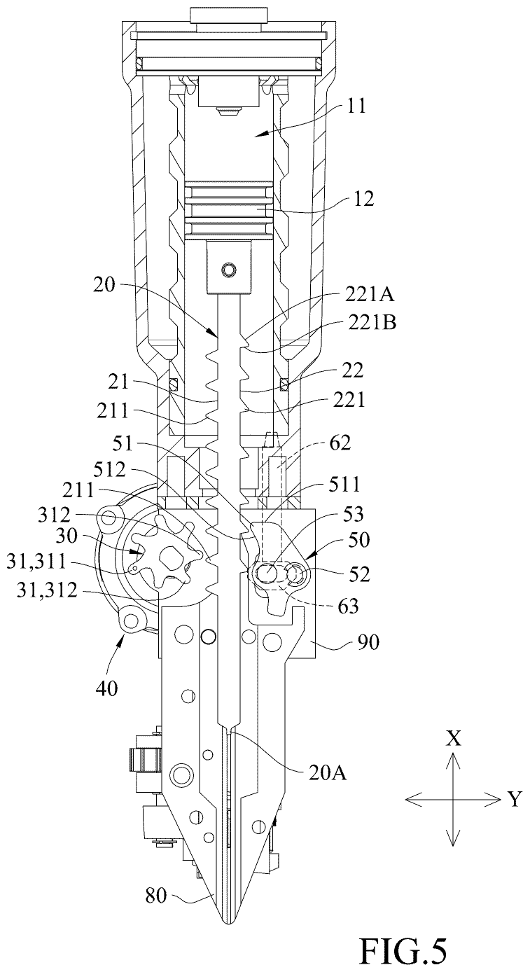

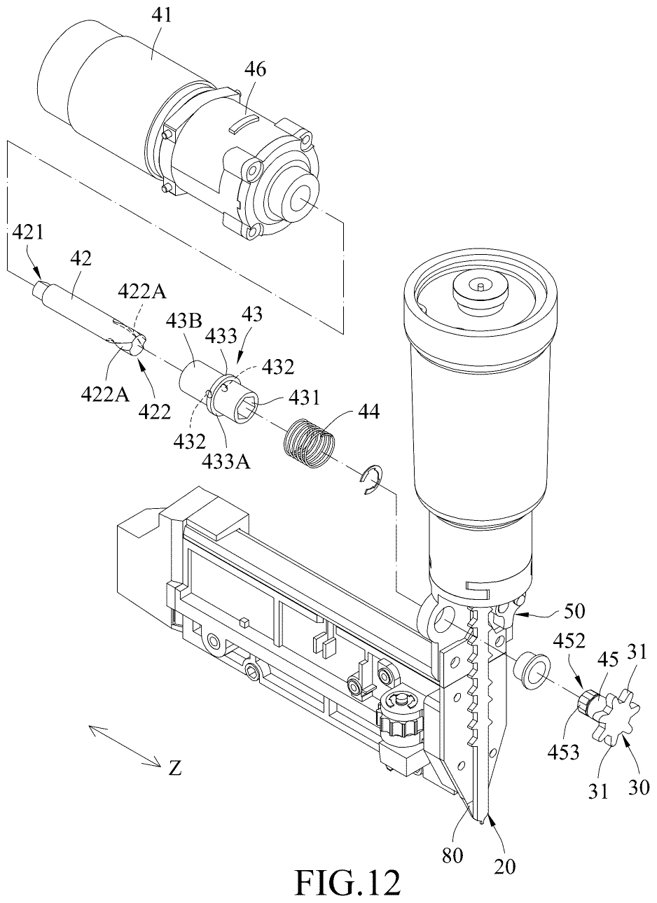

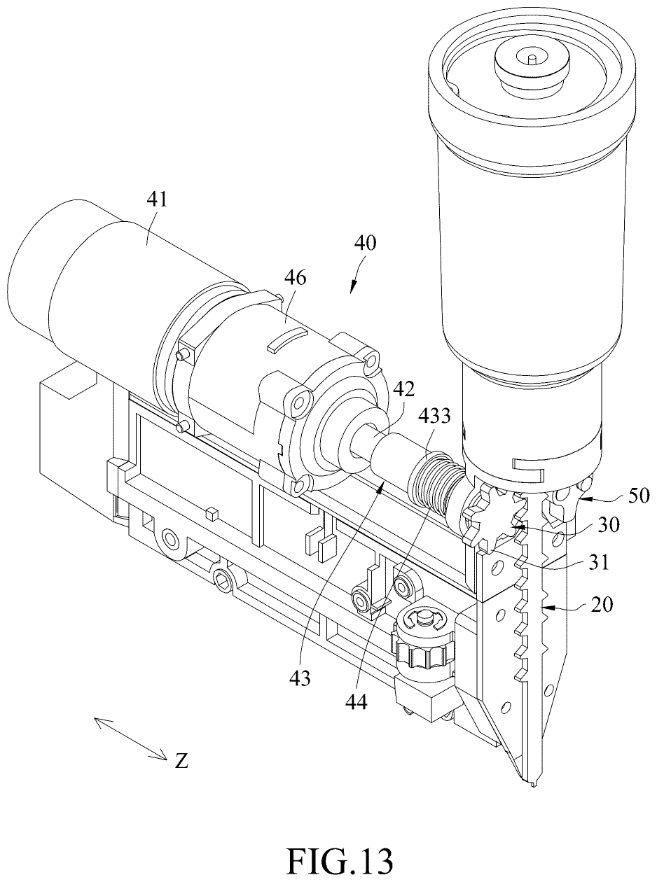

The present invention provides a striker lifting mechanism of a power tool, as shown in FIGS. 1-16, which includes:

A striker drive mechanism 10, which includes a cylinder 11 and a piston 12 located inside the cylinder 11. The piston 12 can move up and down within the cylinder 11.

A striker 20 is power-connected to the striker drive mechanism 10. The striker drive mechanism 10 can drive the striker 20 to displace along an axial direction X. One end of the striker 20 along the axial direction X is connected to the piston 12 and can move up and down with the piston 12. The other end of the striker 20 along the axial direction X includes a striking section 20A. The striker 20 includes a first side surface 21 and a second side surface 22 opposite to each other along a transverse direction Y. The transverse direction Y is perpendicular to the axial direction X. The first side surface 21 includes a plurality of climbing teeth 211, which are arranged at intervals along the axial direction X. The second side surface 22 includes a plurality of stop teeth 221, which are also arranged at intervals along the axial direction X. Each of the stop teeth 221 includes an inclined surface 221A and a stop surface 221B. One end of the inclined surface 221A and one end of the stop surface 221B are connected to each other. The extension direction of the inclined surface 221A has components in the axial direction X and the transverse direction Y. The inclined surface 221A faces the striker drive mechanism 10, and the stop surface 221B faces away from the striker drive mechanism 10. The stop surface 221B is generally planar. In this embodiment, the stop surface 221B extends along the transverse direction Y. During the operation of the striker 20, it will move to an upper dead center P3, a lower dead center P1, and a standby position P2. The upper dead center P3 refers to the position where the striker 20 is pulled to the highest point. At this time, it is ready to fire, having stored enough kinetic energy to prepare for nailing operation. The lower dead center P1 refers to the lowest point position that the striker 20 reaches after completing the firing (nailing) action. The standby position P2 is located between the upper dead center P3 and the lower dead center P1.

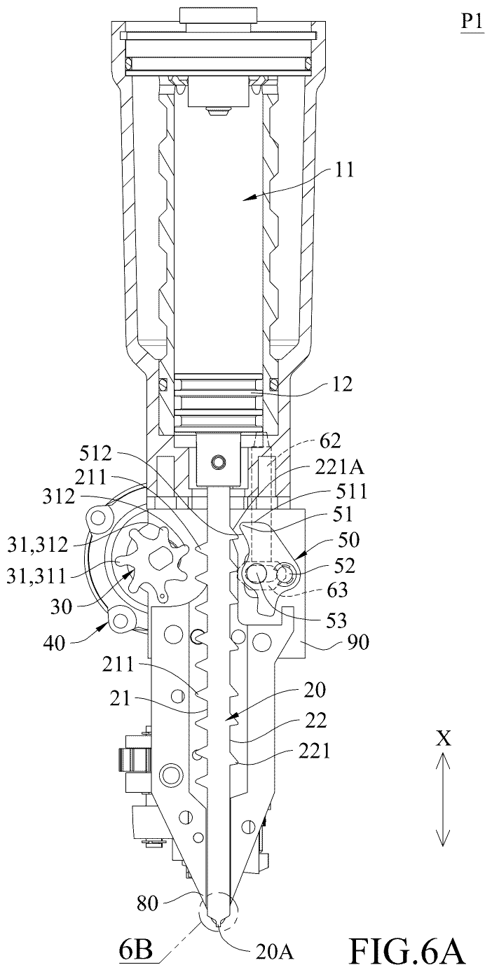

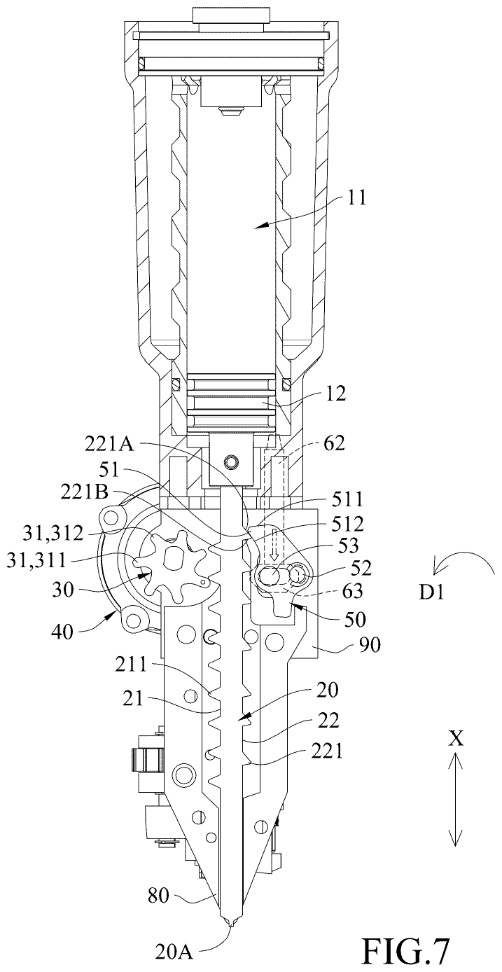

In a preferred embodiment, as shown in FIG. 6B, the striker 20 is additionally provided with a housing 80. The housing 80 includes a pointed tip 81. When the striker 20 moves down to the lower dead center P1, the striking section 20A extends out of the pointed tip 81 of the housing 80 to ensure nailing operation. Also, as shown in FIG. 8B, when the striker 20 moves up from the lower dead center P1 to the standby position P2, the striking section 20A retracts into the pointed tip 81 of the housing 80 to ensure safety in use.

A gear 30 is assembled on one side of the striker 20. The gear 30 is adjacent to the first side surface 21. The gear 30 includes at least one driving tooth 31 configured to abut against the climbing tooth 211 to lift the climbing tooth 211, thereby driving the striker 20 to move up along the axial direction X. In this embodiment, the gear 30 includes a plurality of driving teeth 31, which are annularly distributed on the outer periphery of the gear 30.

A gear drive mechanism 40 is power-connected to the gear 30 to drive the gear 30 to rotate. For example, the gear drive mechanism 40 includes a main shaft 411. The main shaft 411 is inserted through the gear 30 to drive the gear 30 to rotate. There is a power-transmission state and a power-separation state between the gear drive mechanism 40 and the climbing teeth 211. When the gear drive mechanism 40 and the climbing teeth 211 are in the power-transmission state, the climbing teeth 211 can be lifted by the driving teeth 31 of the gear 30 to drive the striker 20 to move up. When the gear drive mechanism 40 and the climbing teeth 211 are in the power-separation state, the striker 20 can move downward along the axial direction X without being interfered with or restricted by the gear 30. In this embodiment, the gear drive mechanism 40 includes a motor 41, and the motor 41 has the main shaft 411, but it is not limited thereto.

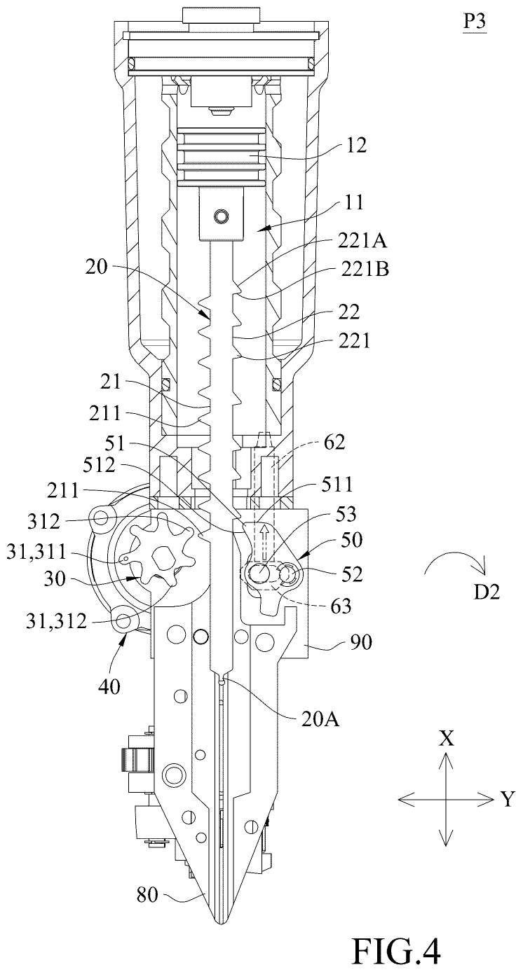

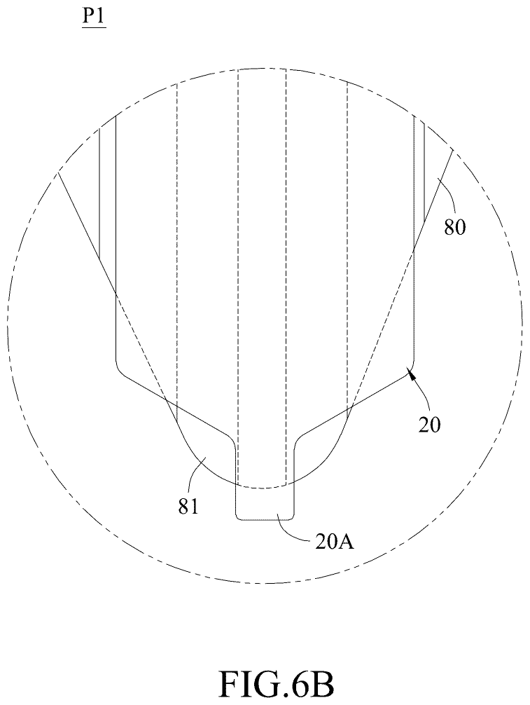

A stop member 50 is assembled on the other side of the striker 20. The stop member 50 is adjacent to the second side surface 22. The stop member 50 includes a top end 50A and a bottom end 50B opposite to each other. The top end 50A includes a convex portion 51. The convex portion 51 includes a limiting surface 511 and an abutting surface 512. One end of the limiting surface 511 is connected to one end of the abutting surface 512. The limiting surface 511 is generally planar, and the abutting surface 512 is inclined. In this embodiment, the limiting surface 511 generally extends along the transverse direction Y. The inclined direction of the abutting surface 512 is the same as or similar to the inclined direction of the inclined surface 221A. The limiting surface 511 is configured to abut against the stop surface 221B of the stop tooth 221, and the abutting surface 512 is configured to abut against the inclined surface 221A of the stop tooth 221. The stop member 50 can be in an abutting state or a separated state. When the stop member 50 is in the abutting state, as shown in FIG. 7, the convex portion 51 is in contact with the stop tooth 221. When the stop member 50 is in the separated state, as shown in FIG. 4, the convex portion 51 is away from the stop tooth 221.

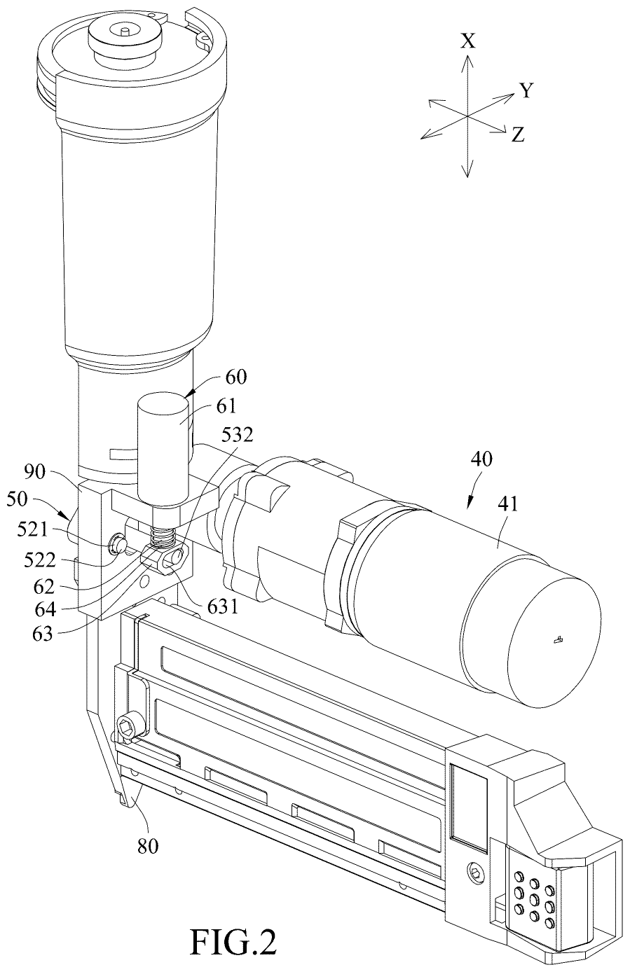

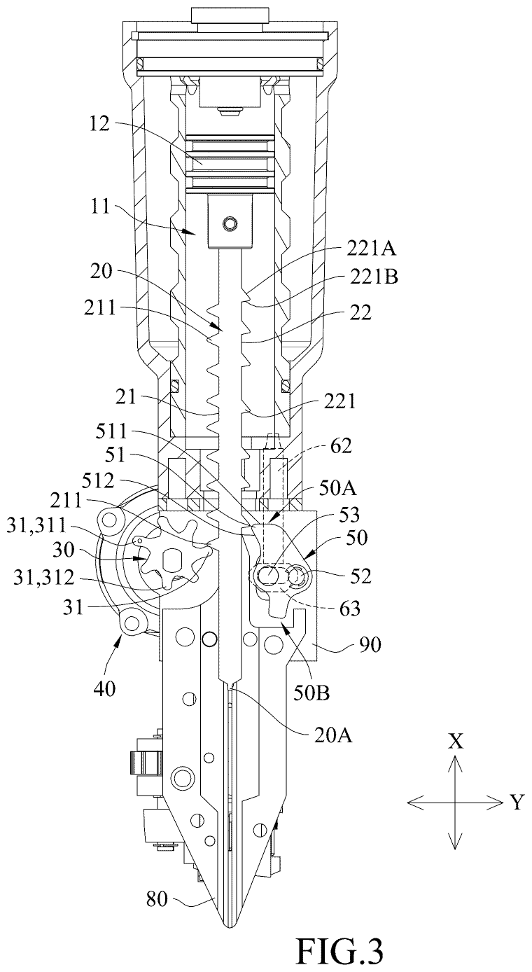

As shown in FIG. 3, the stop member 50 includes a pivoting portion 52 and a moving portion 53 between the top end 50A and the bottom end 50B. The pivoting portion 52 and the moving portion 53 are arranged side by side along the transverse direction Y. The pivoting portion 52 is pivotally installed on a base 90, so that the stop member 50 can pivot relative to the base 90. The moving portion 53 can move along the axial direction X. When the moving portion 53 moves upward along the axial direction X, the stop member 50 rotates along a first direction D1, and the convex portion 51 gradually approaches the stop tooth 221. When the moving portion 53 moves downward along the axial direction X, the stop member 50 rotates along a second direction D2, which is opposite to the first direction D1, and the convex portion 51 gradually moves away from the stop tooth 221. In this embodiment, as shown in FIGS. 1 and 2, the pivoting portion 52 includes a first through-hole 521 and a pivot shaft 522. The pivot shaft 522 is inserted in the first through-hole 521 and the base 90. The moving portion 53 includes a second through-hole 531 and a moving shaft 532. The moving shaft 532 is inserted in the second through-hole 531.

A stop-member drive mechanism 60 is power-connected to the stop member 50. As shown in FIG. 2, the stop-member drive mechanism 60 is configured to drive the stop member 50 to swing. The stop-member drive mechanism 60 includes a power source 61, a drive rod 62, a sleeve 63, and a reset mechanism 64. The power source 61 is installed on the base 90. The power source 61 is power-connected to the drive rod 62. The power source 61 drives the drive rod 62 to move along the axial direction X. One end of the drive rod 62 extends into the power source 61, and the other end of the drive rod 62 is connected to the sleeve 63. The sleeve 63 is generally annular and includes an elongated hole 631, which extends along the transverse direction Y. The reset mechanism 64 is sleeved onto the drive rod 62. One end of the reset mechanism 64 abuts against the sleeve 63, and the other end of the reset mechanism 64 abuts against the power source 61 or the base 90, so that the reset mechanism 64 provides the kinetic energy for the sleeve 63 to reset. In this embodiment, the reset mechanism 64 is a spring. One end of the moving shaft 532 that is not inserted in the second through-hole 531 is inserted in the elongated hole 631. The power source 61 is configured to drive the drive rod 62 to drive the sleeve 63 and the moving shaft 532 to move along the axial direction X, making the sleeve 63 approach the power source 61, as shown in FIG. 4, then the moving portion 53 of the stop member 50 is driven to move up, causing the stop member 50 to rotate along the second direction D2. Then, the convex portion 51 gradually moves away from the stop tooth 221, making the stop member 50 in the separated state. As shown in FIG. 2, when the power source 61 does not drive the drive rod 62 or drives the drive rod 62 in the reverse direction, the reset mechanism 64 drives the sleeve 63 and the moving shaft 532 to move in the reverse direction along the axial direction X, making the sleeve 63 move away from the power source 61. As shown in FIG. 7, the moving portion 53 of the stop member 50 is then driven to move down, causing the stop member 50 to rotate along the first direction D1. The convex portion 51 then gradually approaches the stop tooth 221, making the stop member 50 in the abutting state, thereby stopping the striker 20. When the power source 61 drives and pulls the drive rod 62, the reset mechanism 64 is compressed, the convex portion 51 leaves the stop tooth 221, and the striker 20 is in an un-stopped state, and the nailing operation can be carried out.

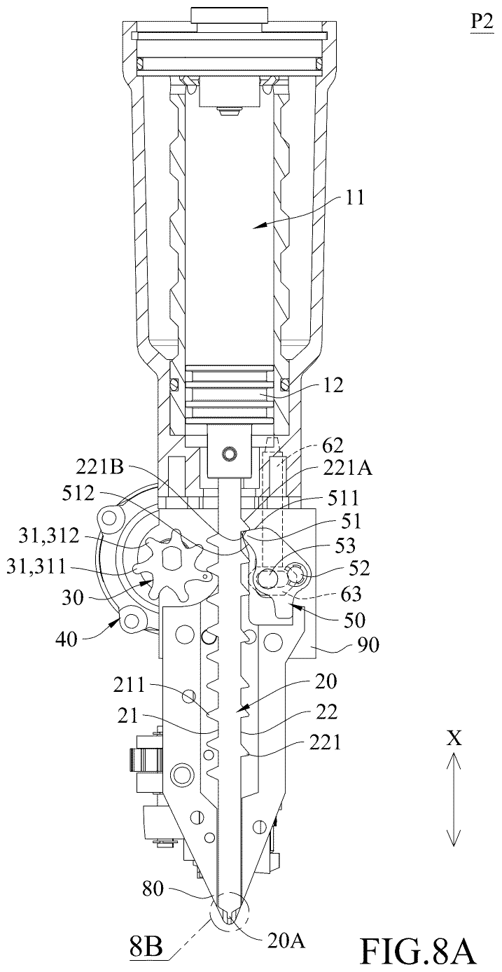

A central control unit 70, as shown in FIG. 9, is control-connected to the gear drive mechanism 40, the striker drive mechanism 10, and the stop-member drive mechanism 60. As shown in FIGS. 6A-8A, when the striker 20 moves to the lower dead center P1, the central control unit 70 drives the gear drive mechanism 40 to rotate, moving the striker 20 up from the lower dead center P1 to the standby position P2, and stops driving the drive rod 62, making the stop member 50 in the abutting state. As shown in FIG. 8A, when the striker 20 moves to the standby position P2, the central control unit 70 stops driving the gear drive mechanism 40 to rotate. When the user pulls the trigger, as shown in FIG. 3, the central control unit 70 drives the gear drive mechanism 40 to rotate, making the driving teeth 31 lift the climbing teeth 211 until the striker 20 moves up from the standby position P2 to the upper dead center P3. After the striker 20 moves to the upper dead center P3, as shown in FIG. 4, the central control unit 70 drives the power source 61 to make the stop member 50 in the separated state. The central control unit 70 makes the striker drive mechanism 10 drive the striker 20 to move down to the lower dead center P1 to ensure nailing operation. In this embodiment, the central control unit 70 can include a circuit board, a control circuit, etc.

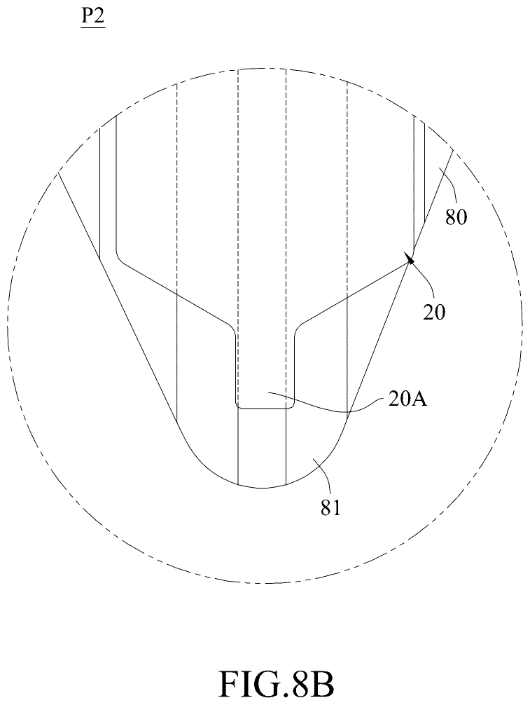

Preferably, as shown in FIG. 10, the invention further includes a monitoring mechanism 71. The monitoring mechanism 71 is signal-connected to the central control unit 70 to monitor the position of the striker 20 to know whether the striker 20 has reached the upper dead center P3, the lower dead center P1, or the standby position P2.

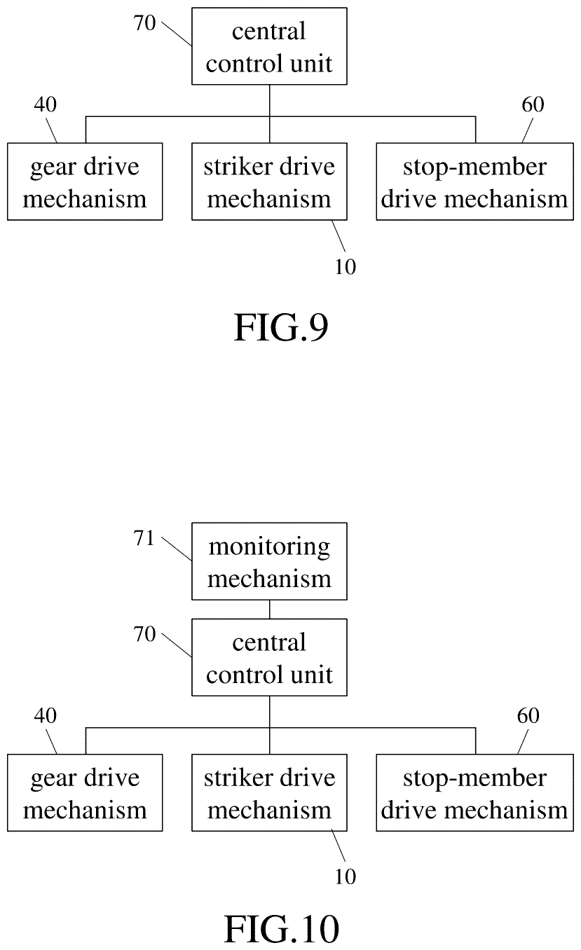

In this embodiment, as shown in FIG. 11, the monitoring mechanism 71 includes a magnet 711 and a reed switch 712. A mounting member 72 is further coupled to the gear 30 and includes a bottom plate 721 and a cover plate 722. The magnet 711 is installed between the bottom plate 721 and the cover plate 722. Both the bottom plate 721 and the cover plate 722 have a through-hole 721A, 722A. The main shaft 411 is inserted and locked in the through-holes 721A, 722A, so that the magnet 711 can rotate synchronously with the gear 30. The magnet 711 is installed on one side of the mounting member 72. The reed switch 712 is fixedly installed on the base 90, so that when the gear 30 rotates, the magnet 711 can periodically pass by the reed switch 712.

When the gear 30 rotates to the upper dead center P3, the position of the magnet 711 corresponds to that of the reed switch 712, sending a signal to the central control unit 70. The central control unit 70 can then control the striker drive mechanism 10 to perform nailing and at the same time drive the power source 61 to make the stop member 50 in the separated state, so that the striker 20 is in a free state and the nailing operation can be carried out. When the gear 30 rotates away from the angle corresponding to the upper dead center P3, the magnet 711 leaves the reed switch 712, and no signal is sent. The power source 61 is not driven or is driven in the reverse direction, so that the stop member 50 normally approaches the striker 20 to stop it.

One embodiment of the striker lifting mechanism of the power tool of the present invention is shown in FIGS. 1-10. Among them:

The gear drive mechanism 40 is the motor 41.

The gear 30 is a cam gear or an eccentric gear, so that the gear 30 can periodically and intermittently contact and drive the climbing teeth 211.

Specifically, as shown in FIGS. 1-8A, the driving teeth 31 include at least one long tooth 311 and at least one short tooth 312, and the long tooth 311 is longer than the short tooth 312. For example, there are four long teeth 311 and three short teeth 312. The four long teeth 311 are located on one side of the gear 30, and the three short teeth 312 are located on the other side of the gear 30. As shown in FIG. 3, when the gear 30 rotates to the position where the long tooth 311 faces the first side surface 21, the long tooth 311 abuts against the climbing tooth 211. At this time, the gear drive mechanism 40 and the climbing teeth 211 are in the power-transmission state. As shown in FIG. 6A, when the gear 30 rotates to the position where the short tooth 312 faces the first side surface 21, the short tooth 312 is at a distance from the climbing tooth 211. As shown in FIG. 4, when the striker 20 moves to the upper dead center P3, the short tooth 312 faces the first side surface 21. At this time, the gear drive mechanism 40 and the climbing teeth 211 are in the power-separation state.

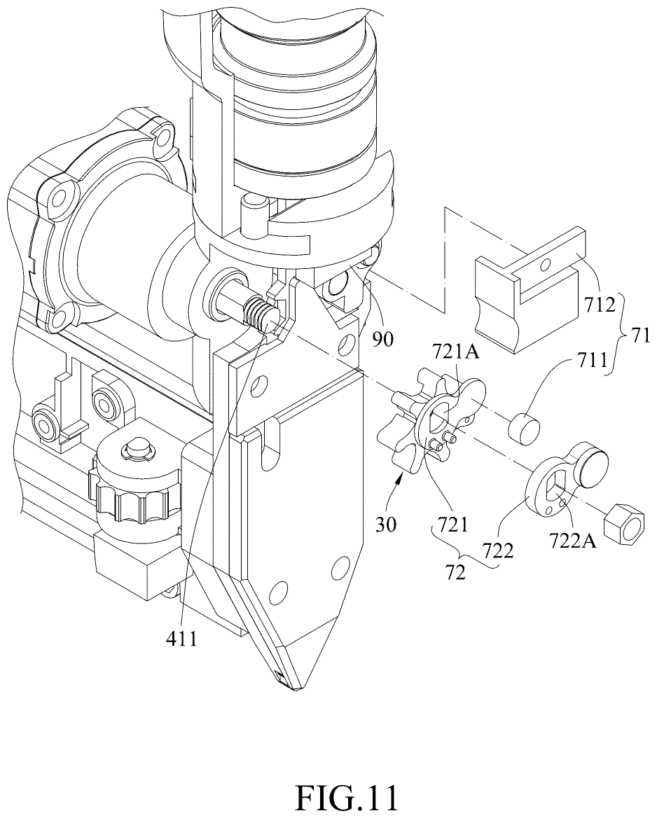

Another embodiment of the striker lifting mechanism of the power tool of the present invention is shown in FIGS. 12-16. Among them:

The gear drive mechanism 40 includes a motor 41, a guide rod 42, a moving block 43, a pushing mechanism 44, and a cylindrical member 45.

The guide rod 42 extends along a front-rear direction Z which is perpendicular to the axial direction X and the transverse direction Y. The guide rod 42 includes a first end 421 and a second end 422 opposite to each other along the front-rear direction Z. The first end 421 is power-connected to the motor 41. For example, the first end 421 is inserted in the through-hole or sleeved onto the shaft of the motor 41. The motor 41 is configured to drive the guide rod 42 to rotate. The second end 422 includes two spiral grooves 422A, which are symmetrically located on two opposite sides of the guide rod 42.

The moving block 43 is generally in a hollow cylindrical shape, extends along the front-rear direction Z and can move along this direction. The moving block 43 includes a through-hole 431 and further includes an inner circumferential surface 43A and an outer circumferential surface 43B which are opposite to each other. The inner circumferential surface 43A faces the through-hole 431, and the outer circumferential surface 43B faces away from the through-hole 431. The through-hole 431 includes a first hole section 431A and a second hole section 431B, which are arranged along the front-rear direction Z. The first hole section 431A is a cylindrical hole, and the second hole section 431B is a hexagonal hole. The inner circumferential surface 43A includes two projections 432, which are symmetrically located at opposite positions on the inner circumferential surface 43A. The two projections 432 are located in the first hole section 431A. One end of the guide rod 42 with the two spiral grooves 422A extends into the first hole section 431A in such a manner that one of the projections 432 is located in one of the spiral grooves 422A, and the other projection 432 is located in the other spiral groove 422A. The two projections 432 can move within the two spiral grooves 422A. The outer circumferential surface 43B includes a rib 433 which is in an annular shape. The rib 433 includes a side end-face 433A, and the side end-face 433A faces away from the motor 41.

The cylindrical member 45 is inserted in the base 90 and can rotate relative to the base 90. The gear 30 is located on one side of the base 90, and the moving block 43 is located on the other side of the base 90. The cylindrical member 45 includes a connecting end 451 and a drive end 452. The connecting end 451 is connected to the gear 30. The drive end 452 includes an engaging section 453, which is in the shape of a polygonal prism. The engaging section 453 is configured to extend into the second hole section 431B. Since the engaging section 453 is a polygonal prism and the second hole section 431B is a hexagonal hole, the cylindrical member 45 can rotate synchronously with the moving block 43.

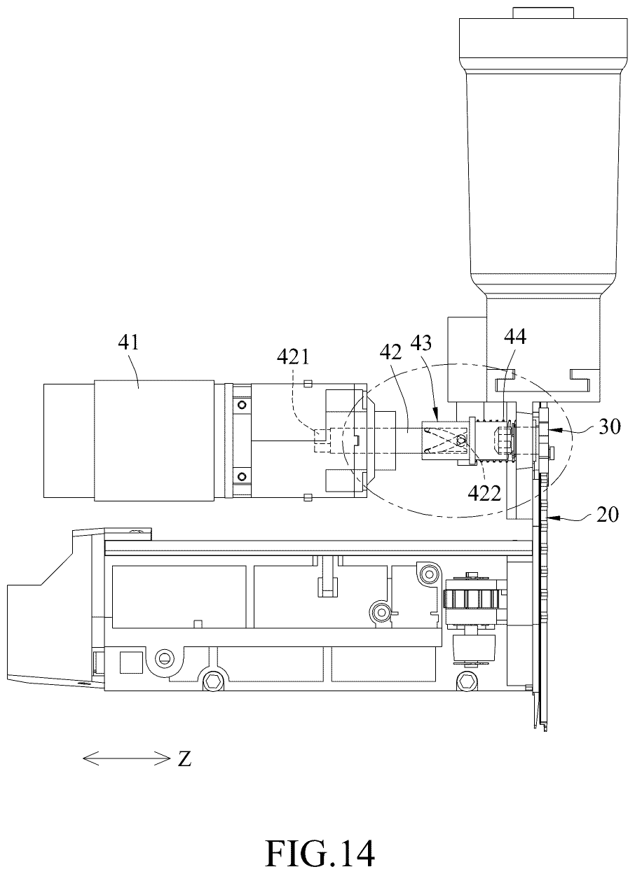

The pushing mechanism 44 is sleeved on the outer circumferential surface 43B of the moving block 43 and the cylindrical member 45. One end of the pushing mechanism 44 abuts against the side end-face 433A, and the other end abuts against the base 90. In this embodiment, the pushing mechanism 44 is a spring. As shown in FIG. 15, when the motor 41 starts to drive the guide rod 42 to rotate, the two projections 432 are driven to move along the two spiral grooves 422A, thereby pushing the moving block 43 to move along the front-rear direction Z towards the cylindrical member 45, which makes the engaging section 453 of the cylindrical member 45 extend into the second hole section 431B. Consequently, The rib 433 of the moving block 43 compresses the pushing mechanism 44, providing a pre-force for the pushing mechanism 44 to reset. When the two projections 432 move to the end of the stroke, the moving block 43 stops moving along the front-rear direction Z. The moving block 43 can then rotate synchronously with the guide rod 42 and the cylindrical member 45, thereby driving the cylindrical member 45 and the gear 30 to rotate. At this time, the gear drive mechanism 40 and the climbing teeth 211 are in the power-transmission state.

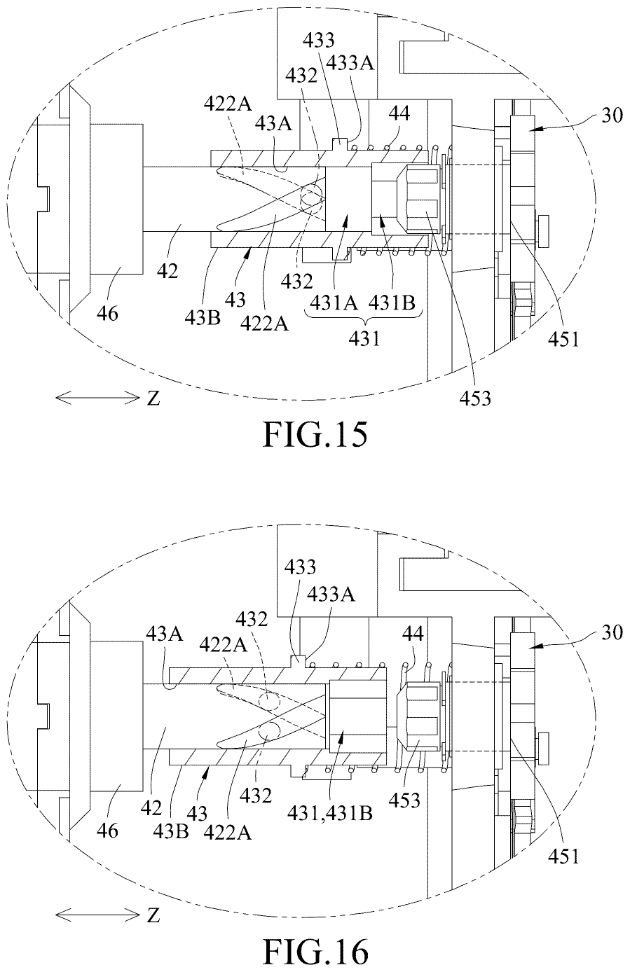

Further, as shown in FIG. 16, when the motor 41 stops rotating, the pushing mechanism 44 pushes the moving block 43 to move in the reverse direction along the front-rear direction Z, making the moving block 43 move away from the cylindrical member 45, and the two projections 432 are driven to move in the reverse direction along the two spiral grooves 422A, causing the cylindrical member 45 to leave the second hole section 431B. As a result, the cylindrical member 45 is separated from the moving block 43, and the moving block 43 can no longer rotate synchronously with the cylindrical member 45. At this time, the gear drive mechanism 40 and the climbing teeth 211 are in the power-separation state.

Preferably, as shown in FIG. 12, the gear drive mechanism 40 further includes a reduction gear set 46, which is arranged between the motor 41 and the guide rod 42. The motor 41, the reduction gear set 46, and the guide rod 42 are power-connected. The kinetic energy of the rotation of the motor 41 is transmitted to the guide rod 42 through the reduction gear set 46, and the guide rod 42 is inserted into the reduction gear set 46.

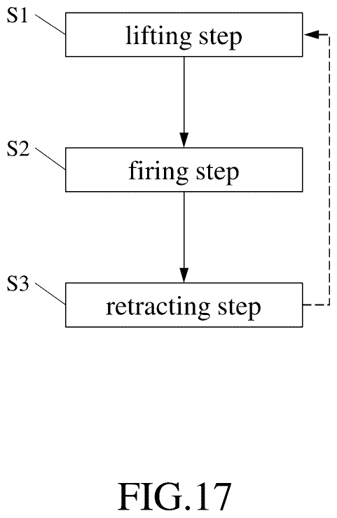

The present invention further provides a safety firing control method for the striker lifting mechanism of a power tool. As shown in FIGS. 3-8B and FIG. 17, the method includes:

A lifting step S1, as shown in FIGS. 3-4, by the central control unit 70, driving the gear drive mechanism 40 to rotate, making the driving teeth 31 lift the climbing teeth 211, so that the striker 20 moves up from the standby position P2 to the upper dead center P3, the stop member 50 remains in the abutting state, and the convex portion 51 of the stop member 50 is in contact with the stop tooth 221. Thus, the striker 20 can move up smoothly, and the downward movement of the striker 20 can be restricted, thereby avoiding misoperation of the striker drive mechanism 10.

A firing step S2, as shown in FIGS. 4-6B, by the power source 61, driving the drive rod 62 to drive the sleeve 63 and the moving shaft 532 to move along the axial direction X, when the striker 20 moves to the upper dead center P3, making the sleeve 63 approach the power source 61 and drive the moving portion 53 of the stop member 50 to move up accordingly. The stop member 50 rotates along the second direction D2, making the stop member 50 in the separated state, and the striker drive mechanism 10 drives the striker 20 to move down to the lower dead center P1 to ensure nailing.

A retracting step S3, as shown in FIGS. 6A-8B, when the striker 20 moves to the lower dead center P1, the gear drive mechanism 40 is driven to rotate, making the driving teeth 31 lift the climbing teeth 211 and driving the striker 20 to move up. The striker 20 moves up from the lower dead center P1 to the standby position P2, making the striking section 20A retract into the pointed tip 81 of the housing 80. The power source 61 does not drive the drive rod 62 to move or drives the drive rod 62 to move in the reverse direction. The reset mechanism 64 drives the sleeve 63 and the moving shaft 532 to move in the reverse direction along the axial direction X, making the sleeve 63 move away from the power source 61 and drive the moving portion 53 of the stop member 50 to move down accordingly. The stop member 50 is in the abutting state, and the convex portion 51 of the stop member 50 is in contact with the stop tooth 221, restricting the downward movement of the striker 20 and thus avoiding the misoperation of the striker drive mechanism 10.

Since both the abutting surface 512 and the inclined surface 221A are inclined surfaces, and the inclined surface 221A faces the striker drive mechanism 10, when the stop member 50 is in the abutting state and the striker 20 moves up, the abutting surface 512 can slide along the inclined surface 221A, guiding the stop member 50 to rotate slightly along the second direction D2. Thus, the convex portion 51 can cross over the stop tooth 221, allowing the striker 20 to move up smoothly. Conversely, since the stop surface 221B and the limiting surface 511 are generally planar, the stop surface 221B can abut against the limiting surface 511, preventing the striker 20 from moving down and misfiring.

As is evident from the foregoing, once the gear drive mechanism 40 is power-connected to the gear 30, and a power-transmission state and a power-separation state exist between the gear drive mechanism 40 and the climbing teeth 211, the driving teeth 31 of the gear 30 are capable of lifting the climbing teeth 211 and driving the striker 20 to move upward. Meanwhile, this setup ensures that no interference or restriction occurs during the downward movement of the striker 20. In addition, the stop-member drive mechanism 60 drives the stop member 50 to swing to the abutting state or the separated state. The abutting state ensures that the striker 20 will not be interfered with or restricted when moving up, and can prevent the striker 20 from moving down due to accidental touch at the standby position P2 or when moving up. The separated state ensures that the striker 20 can quickly move from the upper dead center P3 to the lower dead center P1, providing a striker lifting mechanism and a firing safety device with a simple structure and good safety.

1. A striker lifting mechanism of a power tool, comprising:
a striker drive mechanism configured to drive a striker to move;
the striker being power-connected to the striker drive mechanism and including a first side surface and a second side surface opposite to each other, the first side surface including a plurality of climbing teeth, the second side surface including a plurality of stop teeth, wherein each of the stop teeth includes an inclined surface and a stop surface, and the stop surface faces away from the striker drive mechanism;
a gear assembled on one side of the striker and including at least one driving tooth configured to abut against the climbing teeth to lift the climbing teeth;
a gear drive mechanism power-connected to the gear to drive the gear to rotate;
a stop member assembled on another side of the striker and including a convex portion, wherein the convex portion includes a limiting surface and an abutting surface, the limiting surface is configured to abut against the stop surface of the stop teeth, the abutting surface is configured to abut against the inclined surface of the stop teeth, the stop member is capable of being in an abutting state or a separated state, when the stop member is in the abutting state, the convex portion is in contact with the stop teeth, and when the stop member is in the separated state, the convex portion is away from the stop teeth;
a stop-member drive mechanism power-connected to the stop member and configured to drive the stop member to swing to the abutting state or the separated state;
a central control unit control-connected to the gear drive mechanism, the striker drive mechanism, and the stop-member drive mechanism, wherein the central control unit controls the gear drive mechanism to rotate or stop rotating, the central control unit controls the gear drive mechanism drive the striker to move, and the central control unit controls the stop-member drive mechanism to drive the stop member to swing; and
one end of the striker that is not connected to the striker drive mechanism includes a striking section, the striker is further provided with a housing, the housing includes a pointed tip, the striker is capable of moving down to an upper dead center, a lower dead center, and a standby position, when the striker is in the lower dead center, the striking section extends out of the pointed tip of the housing, when the striker is in the standby position, the striking section retracts into the pointed tip of the housing, when the striker is in the standby position, the striking section is close to the pointed tip, and when the striker is in the upper dead center, the striking section is away from the pointed tip.

2. The striker lifting mechanism of the power tool as claimed in claim 1, wherein the striker drive mechanism includes a cylinder and a piston located inside the cylinder, the piston is movable in the cylinder, and one end of the striker is connected to the piston.

3. The striker lifting mechanism of the power tool as claimed in claim 1, wherein the abutting surface is inclined, and an inclined direction of the abutting surface is similar to that of the inclined surface.

4. The striker lifting mechanism of the power tool as claimed in claim 1, wherein the stop member includes a top end and a bottom end opposite to each other, the convex portion is located on the top end, the stop member includes a pivoting portion and a moving portion between the top end and the bottom end, the stop member swings with the pivot portion as a pivot center, the moving portion is capable of linear displacement, when the moving portion moves in one direction, the stop member swings along a first direction, and the convex portion approaches the stop teeth, and when the moving portion moves in an opposite direction, the stop member swings along a second direction, the second direction is opposite to the first direction, and the convex portion moves away from the stop teeth.

5. The striker lifting mechanism of the power tool as claimed in claim 4, wherein the pivoting portion is pivotally installed on a base, and the stop member is able to pivot relative to the base.

6. The striker lifting mechanism of the power tool as claimed in claim 5, wherein the pivoting portion includes a first through-hole and a pivot shaft, the pivot shaft is inserted in the first through-hole and the base, the moving portion includes a second through-hole and a moving shaft, the moving shaft is inserted in the second through-hole, the stop-member drive mechanism includes a power source, a drive rod, a sleeve, and a reset mechanism, the power source is installed on the base, the power source is power-connected to the drive rod, the power source drives the drive rod to move, the drive rod is connected to the sleeve, the sleeve includes an elongated hole, the reset mechanism is sleeved onto the drive rod, one end of the reset mechanism abuts against the sleeve, and another other end of the reset mechanism abuts against the power source or the base, one end of the moving shaft that is not inserted in the second through-hole is inserted in the elongated hole, the power source is configured to drive the drive rod to drive the sleeve and the moving shaft to move, the sleeve is capable of approaching or moving away from the power source.

7. The striker lifting mechanism of the power tool as claimed in claim 1 further comprising a monitoring mechanism, wherein the monitoring mechanism is signal-connected to the central control unit to monitor position of the striker.

8. The striker lifting mechanism of the power tool as claimed in claim 7, wherein the monitoring mechanism includes a magnet and a reed switch, a mounting member is coupled to the gear, the magnet is installed on the mounting member, the mounting member includes a through-hole, the gear drive mechanism includes a main shaft, the main shaft is inserted and locked in the through-hole, and the reed switch is fixedly installed on a base.

9. The striker lifting mechanism of the power tool as claimed in claim 1, wherein the gear drive mechanism includes a motor, the gear is a cam gear or an eccentric gear, and the gear periodically and intermittently contacts the climbing teeth.

10. The striker lifting mechanism of the power tool as claimed in claim 1, wherein the gear includes a plurality of said driving teeth, the driving teeth each include at least one long tooth and at least one short tooth, the at least one long tooth is longer than the at least one short tooth, the at least one long tooth is located on one side of the gear, and the at least one short tooth is located on another side of the gear, when the at least one long tooth faces the first side surface, the at least one long tooth abuts against the climbing teeth, when the at least one short tooth faces the first side surface, the at least one short tooth is at a distance from the climbing teeth.

11. The striker lifting mechanism of the power tool as claimed in claim 1, wherein the gear drive mechanism includes a motor, a guide rod, a moving block, a pushing mechanism, and a cylindrical member;
the guide rod includes a first end and a second end opposite to each other, the first end is power-connected to the motor, the motor is configured to drive the guide rod to rotate, the second end includes a plurality of spiral grooves;
the moving block is movable relative to the guide rod, the cylindrical member is capable of extending into or moving out of the moving block, the moving block includes a through-hole and further includes an inner circumferential surface and an outer circumferential surface which are opposite to each other, the inner circumferential surface faces the through-hole, the outer circumferential surface faces away from the through-hole, the through-hole includes a first hole section and a second hole section, the inner circumferential surface includes a plurality of projections located in the first hole section, one end of the guide rod with the spiral grooves extends into the first hole section, the plurality of projections are located in the spiral grooves, and the outer circumferential surface includes a rib;
the cylindrical member includes a connecting end and a drive end, the connecting end is connected to the gear, the drive end is configured to extend into or move away from the second hole section, the drive end is configured to engage with the inner circumferential surface of the second hole section, the cylindrical member is capable of rotating synchronously with the moving block; and
the pushing mechanism is sleeved on the moving block and the cylindrical member, one end of the pushing mechanism abuts against the rib, and another end of the pushing mechanism is fixed.

12. The striker lifting mechanism of the power tool as claimed in claim 11, wherein the first hole section is a cylindrical hole, and the second hole section is a hexagonal hole, the drive end includes an engaging section in the shape of a polygonal prism.

13. The striker lifting mechanism of the power tool as claimed in claim 11, wherein the cylindrical member is inserted in the base and capable of rotating relative to the base, the gear is located on one side of the base, and the moving block is located on another side of the base, the rib includes a side end-face, the side end-face faces away from the motor, one end of the pushing mechanism abuts against the side end-face, and another other end of the pushing mechanism abuts against the base.

14. The striker lifting mechanism of the power tool as claimed in claim 9, wherein the gear drive mechanism further includes a reduction gear set, and the reduction gear set is arranged between the motor and the gear.

15. (canceled)

16. (canceled)

17. A safety firing control method for the striker lifting mechanism of the power tool as claimed in claim 6, comprising:
a lifting step: having a power-transmission state between the gear drive mechanism and the climbing teeth, by the central control unit, driving the gear drive mechanism to rotate, by the driving tooth, lifting the climbing teeth, the striker moving upward from the standby position to the upper dead center, the stop member being in an abutting state, and the convex portion of the stop member contacting the stop teeth;
a firing step: driving the stop member to be in a separated state when the striker moves to the upper dead center, so as to have a power-separation state between the gear drive mechanism and the climbing teeth, and the striker drive mechanism driving the striker to move downward to the lower dead center;
a retracting step: having the power-transmission state between the gear drive mechanism and the climbing teeth when the striker moves to the lower dead center, driving the gear drive mechanism to rotate, the driving tooth lifting the climbing teeth, driving the striker to move upward from the lower dead center to the standby position, driving the stop member to be in an abutting state, and the convex portion of the stop member contacting the stop teeth; and
in the firing step, by the power source, driving the drive rod to drive the sleeve and the moving shaft to move, making the sleeve approach the power source and drive the moving portion to move up accordingly, making the stop member in a separated state, and in the retracting step,
the power source does not drive the drive rod to move or drives the drive rod to move in the reverse direction, the reset mechanism drives the sleeve and the moving shaft to move in a reverse direction, making the sleeve move away from the power source and drive the moving portion to move down accordingly, and the stop member is in the abutting state.

18. A safety firing control method for the striker lifting mechanism of the power tool as claimed in claim 10, comprising:
a lifting step: having a power-transmission state between the gear drive mechanism and the climbing teeth, by the central control unit, driving the gear drive mechanism to rotate, by the driving tooth, lifting the climbing teeth, the striker moving upward from the standby position to the upper dead center, the stop member being in an abutting state, and the convex portion of the stop member contacting the stop teeth;
a firing step: driving the stop member to be in a separated state when the striker moves to the upper dead center, so as to have a power-separation state between the gear drive mechanism and the climbing teeth, and the striker drive mechanism driving the striker to move downward to the lower dead center;
a retracting step: having the power-transmission state between the gear drive mechanism and the climbing teeth when the striker moves to the lower dead center, driving the gear drive mechanism to rotate, the driving tooth lifting the climbing teeth, driving the striker to move upward from the lower dead center to the standby position, driving the stop member to be in an abutting state, and the convex portion of the stop member contacting the stop teeth; and
in the lifting step and the retracting step, the at least one long tooth abuts against the climbing teeth, and in the firing step, the at least one short tooth is at a distance from the climbing teeth.

19. A safety firing control method for the striker lifting mechanism of the power tool as claimed in claim 11, comprising:
a lifting step: having a power-transmission state between the gear drive mechanism and the climbing teeth, by the central control unit, driving the gear drive mechanism to rotate, by the driving tooth, lifting the climbing teeth, the striker moving upward from the standby position to the upper dead center, the stop member being in an abutting state, and the convex portion of the stop member contacting the stop teeth;
a firing step: driving the stop member to be in a separated state when the striker moves to the upper dead center, so as to have a power-separation state between the gear drive mechanism and the climbing teeth, and the striker drive mechanism driving the striker to move downward to the lower dead center;
a retracting step: having the power-transmission state between the gear drive mechanism and the climbing teeth when the striker moves to the lower dead center, driving the gear drive mechanism to rotate, the driving tooth lifting the climbing teeth, driving the striker to move upward from the lower dead center to the standby position, driving the stop member to be in an abutting state, and the convex portion of the stop member contacting the stop teeth;
in the lifting step and the retracting step, the motor drives the guide rod to rotate, the plurality of projections move along the spiral grooves, the moving block rotates synchronously with the guide rod and the cylindrical member, driving the cylindrical member and the gear to rotate; and
in the firing step, the motor stops rotating, the pushing mechanism pushes the moving block to displace in a reverse direction, the moving block moves away from the cylinder, driving the plurality of projections to displace along the spiral grooves in the reverse direction, and the cylindrical member is separated from the moving block.
